(19) United States
(12) Patent Application Publication
(10) Pub. No.: US 2007/0277910 A1
(43) Pub. Date: Dec. 6, 2007

(54) Manufacturing method of tunnel magnetoresistance element and manufacturing method of nonvolatile memory device

(75) Inventors: Takao Ochiai, Kawasaki (JP); Shinjiro Umehara, Kawasaki (JP); Hiroshi Ashida, Kawasaki (JP); Masashige Sato, Kawasaki (JP); Kazuo Kobayashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/606,164

(22) Filed: Nov. 30, 2006

(30) Foreign Application Priority Data
May 30, 2006 (JP) 2006-150210

(51) Int. Cl. H01F 41/22

(52) U.S. Cl. 148/121

(57) ABSTRACT

An electrode, an antiferromagnetic film, a ferromagnetic film, a nonmagnetic film, a ferromagnetic film, a tunnel insulating film, a ferromagnetic film, a first Ta film, a Ru film, and a second Ta film are formed in sequence on a substrate. The thickness of the second Ta film is about 0.5 nm. The second Ta film is naturally oxidized after being formed. Then, heat treatment to improve the characteristic of a TMR film is performed. The temperature of this heat treatment is approximately from 200° C. to 300° C. In a conventional manufacturing method, film peeling occurs in this heat treatment, and accompanying this, defects such as occurrence of holes and wrinkles further occur, but in the present method, such an occurrence of defects is prevented since the Ta film is formed at the uppermost surface. Subsequently, the Ta film and so on are patterned.

### CROSS-REFERENCE TO RELATED APPLICATIONS

This application is based upon and claims the benefit of priority from the prior Japanese Patent Application No. 2006-150210, filed on May 30, 2006, the entire contents of which are incorporated herein by reference.

### BACKGROUND OF THE INVENTION

1. Field of the Invention

The present invention relates to a manufacturing method of various devices each including a tunnel magnetoresistance film (TMR film).

2. Description of the Related Art

With a recent increase in the capacity of a hard disk drive (HDD), the recording system of a magnetic recording medium has been shifting from an in-plane recording system to a perpendicular magnetic recording system. Accompanying this, also in a magnetic head for reading, a CPP (current perpendicular to plane) system, in which a sense current is passed perpendicular to a recording plane of the magnetic recording medium, is seen as more important than a CIP (current in plane) system, in which the current is passed in the recording plane. Among such CPP-system magnetic heads are a GMR head using a giant magnetoresistance (GMR) effect and a TMR head using a tunnel magnetoresistance (TMR) effect. If the two are compared, the TMR head can obtain a resistance change rate equal to or more than 10 times that of the GMR head. Moreover, the yield of the TMR head is also relatively better.

Accordingly, in recent years, the TMR head has been entering the mainstream of perpendicular recording system reading heads. The TMR head includes a TMR film formed by sandwiching a tunnel insulating film between two ferromagnetic films.

A TMR film at an early stage of development generally uses an aluminum oxide (Al₂O₃) film as the tunnel insulating film (AlOₓ-TMR film), and its magnetoresistance ratio (MR) is about 70% at the maximum (Dexin Wagn et. al., IEEE Trans. on Magn., vol. 40, No. 4, (2004)). Further, recently, a TMR film which uses a MgO film as the tunnel insulating film has been developed. In this TMR film (MgO-TMR film), a resistance change rate (magnetoresistance ratio) exceeding 300% is obtained (shoji Ikeda et. al., Japanese Journal of Applied Physics, vol. 44, L 1442-L 1445 (2005)). This value is equal to or more than 100 times the magnetoresistance ratio when the GMR effect is used. Therefore, the application of the MgO-TMR film to the TMR head attracts much attention, and research and development thereof is being actively performed.

However, as a result of research by the present inventors, it has been found that defects such as occurrence of holes and wrinkles occur in the manufacturing process of the TMR head and further film peeling occurs. FIG. 6 shows this situation. An optical micrograph shown in FIG. 6 is a sample in which a MgO film is used as the tunnel insulating film and a Ru film is formed at the uppermost surface. In the middle of FIG. 6, a hole occurs, and around the hole, many wrinkles occur. Such defects may lead to reductions in yield and reliability.

In Japanese Patent Application Laid-open No. 2002-216321 and Japanese Patent Application Laid-open No. 2000-228003, a technique of forming a stacked body of a Ta film and a Ru film, a Ta film, or the like as a cap layer on the TMR film is disclosed, but film peeling cannot be avoided. Moreover, when the Ta film is left at the uppermost surface, a sufficient electric characteristic cannot be secured by the influence of natural oxidation.

### SUMMARY OF THE INVENTION

An object of the present invention is to provide a manufacturing method of a tunnel magnetoresistance element and a manufacturing method of a nonvolatile memory device capable of suppressing film peeling during a manufacturing process.

The present inventors have made assiduous studies in order to solve the above problems and as a result have found that in a conventional TMR head in which a Ru film is placed as a cap layer at the uppermost surface, film peeling occurs near a tunnel insulating film in heat treatment after a TMR film, an electrode, and so on are formed. This peeling is thought to be caused because the adhesion between the tunnel insulating film and ferromagnetic films (metal films) sandwiching the tunnel insulating film becomes lower.

The present inventors have further made an assiduous study and as a result have found that when hydrogen and moisture are adsorbed on the surface of the uppermost Ru film before the heat treatment, occurrence of wrinkles and the like occurs. On the other hand, it has been found that when a Ta film is formed on the Ru film, the amount of adsorption of hydrogen and moisture on the surface thereof is small and defects such as wrinkles do not occur. Based on these results of studies, the present inventors have reached various aspects of the present invention described below.

In a manufacturing method of a tunnel magnetoresistance element according to the present invention, a first ferromagnetic film is formed, thereafter a tunnel insulating film is formed on the first ferromagnetic film. Then, a second ferromagnetic film is formed on the tunnel insulating film. Subsequently, a ruthenium film electrically connected to the second ferromagnetic film is formed above the second ferromagnetic film. Thereafter, a metal film or a metal oxide film is formed on the ruthenium film. Then, heat treatment of the first ferromagnetic film, the tunnel insulating film, and the second ferromagnetic film is performed.

In a manufacturing method of a nonvolatile memory device according to the present invention, a switching element is formed, thereafter a first ferromagnetic film connected to the switching element is formed. Then, a tunnel insulating film is formed on the first ferromagnetic film. Subsequently, a second ferromagnetic film is formed on the tunnel insulating film. Thereafter, a ruthenium film electrically connected to the second ferromagnetic film is formed above the second ferromagnetic film. Then, a metal film or a metal oxide film is formed on the ruthenium film. Subsequently, heat treatment of the first ferromagnetic film, the tunnel insulating film, and the second ferromagnetic film is performed.

### BRIEF DESCRIPTION OF THE DRAWINGS

FIG. 1A to FIG. 1D are sectional views showing a manufacturing method of a TMR head according to a first embodiment of the present invention step by step;

FIG. 2 is a graph showing the occurrence status of film peeling;

FIG. 3 is a view showing the internal constitution of a hard disk drive (HDD);

FIG. 4 is a schematic view showing the constitution of an MRAM;

FIG. 5A to FIG. 5D are sectional views showing a manufacturing method of a semiconductor memory device (MRAM) according to a second embodiment of the present invention step by step; and

FIG. 6 is an optical micrograph showing the occurrence of holes and wrinkles.

### DETAILED DESCRIPTION OF THE PREFERRED EMBODIMENTS

### First Embodiment

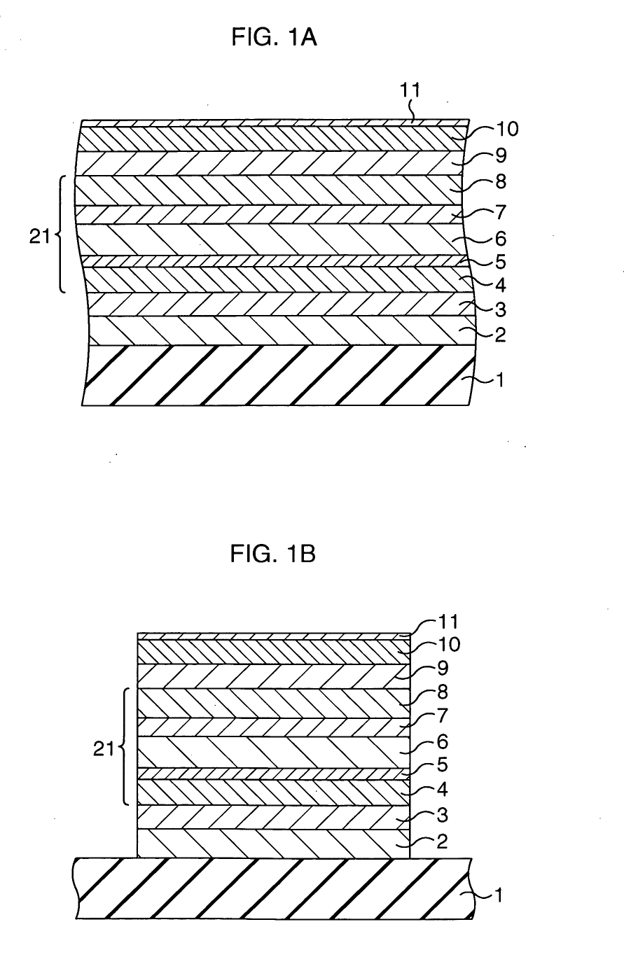

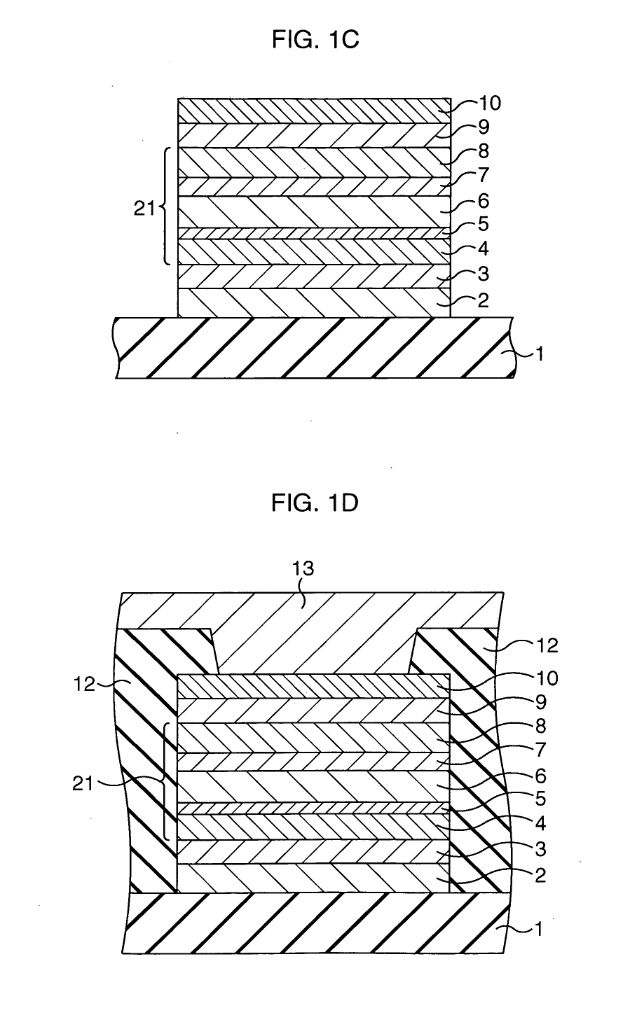

First, a first embodiment of the present invention will be described. FIG. 1A to FIG. 1D are sectional views showing a manufacturing method of a TMR head according to the first embodiment of the present invention step by step.

First, as shown in FIG. 1A, an electrode 2, an antiferromagnetic film 3, a ferromagnetic film 4, a nonmagnetic film 5, a ferromagnetic film 6, a tunnel insulating film 7, a ferromagnetic film 8, a Ta film 9, a Ru film 10, and a Ta film 11 are formed in sequence on a substrate 1, for example, by a sputtering method. As the substrate 1, for example, an AlTiC substrate, a Si substrate, or the like can be used. As the electrode 2, for example, a Ta film, a Ru film, or the like is formed. The thickness of the electrode 2 is, for example, approximately from 5 nm to 40 nm. As the antiferromagnetic film 3, for example, an IrMn film, a PtMn film, or the like is formed. When the IrMn film is formed, its thickness is, for example, approximately from 5 nm to 10 nm. On the other hand, when the PtMn film is formed, its thickness is, for example, approximately from 10 nm to 25 nm. As the ferromagnetic films 4 and 6, for example, a CoFe film, a NiFe film, or the like is formed. The thickness of the ferromagnetic films 4 and 6 is, for example, about 2 nm. As the nonmagnetic film 5, for example, a Ru film, a Rh film, a Cr film, or the like is formed. The thickness of the nonmagnetic film 5 is, for example, about 1 nm. As the tunnel insulating film 7, for example, a MgO film, an Al₂O₃ film, a TiOₓ film, or the like is formed. The thickness of the tunnel insulating film 7 is, for example, about 1 nm. As the ferromagnetic film 8, for example, a CoFe film, a NiFe film, or the like is formed. The thickness of the ferromagnetic film 8 is, for example, approximately from 4 nm to 6 nm. The thickness of the Ta film 9 is, for example, about 5 nm. The thickness of the Ru film 10 is, for example, about 10 nm. The thickness of the Ta film 11 is, for example, about 0.5 nm. Incidentally, the Ta film 11 is naturally oxidized after being formed.

The ferromagnetic film 4, the nonmagnetic film 5, and the ferromagnetic film 6 constitute a magnetization fixed layer. This magnetization fixed layer, the tunnel insulating film 7, and the ferromagnetic film 8 constitute a TMR film 21. By using such a magnetization fixed layer having a stacked ferro-structure, leakage of a magnetic field from the magnetization fixed layer is suppressed, and a bad influence on magnetization in the ferromagnetic film 8, which acts as a magnetization free layer, is suppressed.

After a stacked body such as described above is formed, heat treatment to improve the characteristic of the TMR film 21 is performed. The temperature of this heat treatment is, for example, approximately from 200° C. to 300° C. In a conventional manufacturing method, film peeling occurs in this heat treatment, and accompanying this, defects such as occurrence of holes and wrinkles further occur, but in this embodiment, such an occurrence of defects is prevented since the Ta film 11 is formed at the uppermost surface.

Then, as shown in FIG. 1B, the Ta film 11, the Ru film 10, the Ta film 9, the ferromagnetic film 8, the tunnel insulating film 7, the ferromagnetic film 6, the nonmagnetic film 5, the ferromagnetic film 4, the antiferromagnetic film 3, and the electrode 2 are patterned by a photolithography technique and an etching technique. At this time, the Ta film 9 acts as a part of an etching mask.

Subsequently, the Ru film 10, the Ta film 9, the ferromagnetic film 8, the tunnel insulating film 7, the ferromagnetic film 6, the nonmagnetic film 5, the ferromagnetic film 4, the antiferromagnetic film 3, and the electrode 2 are fabricated into a desired planar shape by an ion milling method or the like. At this time, as shown in FIG. 1C, the extremely thin Ta film 11 disappears. The Ru film 10 and the Ta film 9 act as a cap layer protecting the ferromagnetic film 8.

Thereafter, as shown in FIG. 1D, an insulating film 12 such as a Si oxide film is formed on the entire surface, and an opening which reaches the Ru film 10 is formed in this interlayer insulating film 12. An electrode 13 contacting the Ru film 10 via this opening is formed. Thus, the TMR head is completed.

According to the above manufacturing method, since the Ru film 10 is covered with the Ta film 11 during the heat treatment, defects such as film peeling are suppressed. Accordingly, reductions in yield and reliability can be suppressed. If the Ta film 11 is oxidized, its resistance remarkably increases, but in subsequent fabrication, the Ta film 11 is removed. Further, after the Ta film 11 is removed, the surface of the Ru film 10 is naturally oxidized, but even if the Ru film 10 is oxidized, increase of its resistance is acceptable. Accordingly, no defect caused by the natural oxidation occurs. The above fact that no bad influence is exerted on an electric characteristic is also confirmed by a test on a four-terminal element actually manufactured by the present inventors.

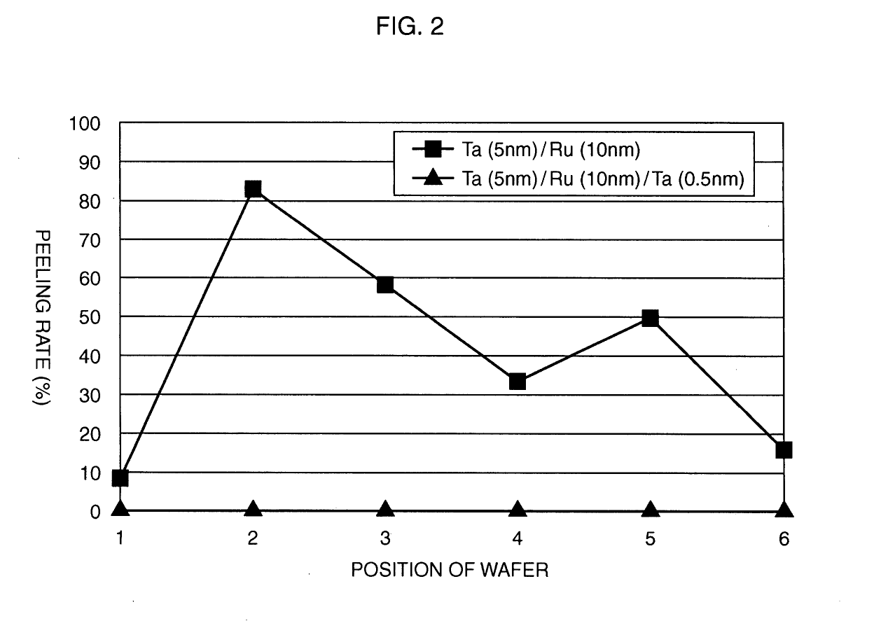

When the present inventors actually performed film formation and heat treatment in accordance with the first embodiment, no film peeling occurred as shown in FIG. 2. The ▴ mark in FIG. 2 shows a result when the treatment was performed in accordance with the first embodiment. On the other hand, the mark ▪ in FIG. 2 is a result when the Ta film 11 was not formed on the Ru film 10. Incidentally, in this test, a silicon wafer was used as the substrate 1. The horizontal axis in FIG. 2 shows measurement positions in the silicon wafer. Such results were obtained also when instead of the Ta film 11, an Al film, a Cu film, a Mg film, or a Ti film is formed. Namely, a result was obtained that film peeling was suppressed when a film of metal having a higher bonding strength with oxygen than Ru was formed.

Incidentally, in the first embodiment, the Ta film 11 is formed and thereafter naturally oxidized, but even if a metal oxide film is formed directly on the Ru film 10, the effect of the present invention can be obtained. The metal oxide film can be formed, for example, by vapor deposition. Examples of such a metal oxide film are a tantalum oxide film, an aluminum oxide film, a copper oxide film, a magnesium oxide film, a titanium oxide film, and so on.

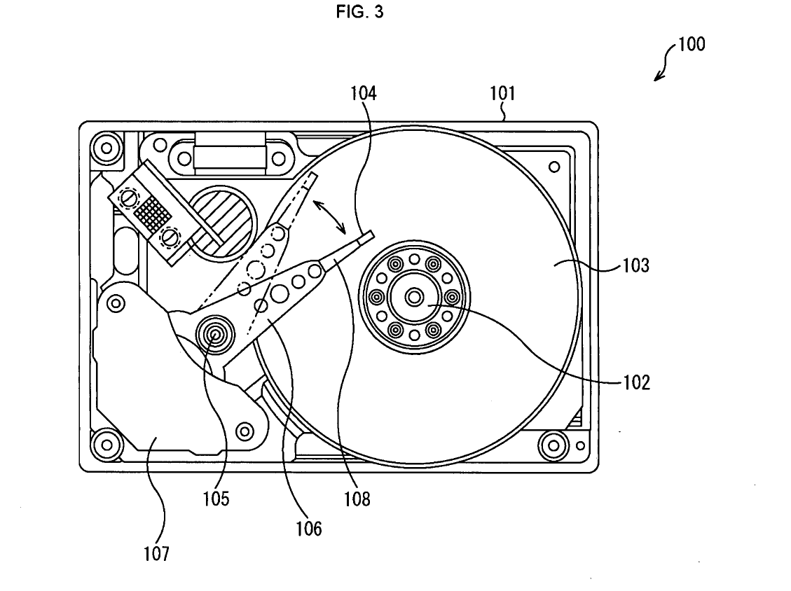

Now, a hard disk drive will be described as an example of a magnetic disk device including the TMR head manufactured according to the first embodiment. FIG. 3 is a view showing the internal constitution of the hard disk drive (HDD).

In a housing 101 of this hard disk drive 100, a magnetic disk 103 which is attached to a rotating shaft 102 and rotates, a slider 104 equipped with a magnetic head which records information onto and reads information from the magnetic disk 103, a suspension 108 which holds the slider 104, a carriage arm 106 to which the suspension 108 is fixed and which moves around an arm shaft 105 along the surface of the magnetic disk 103, and an arm actuator 107 which drives the carriage arm 106 are housed. The magnetic head includes the TMR head manufactured according to the first embodiment. When such a HDD is manufactured, it is only necessary to house the magnetic disk 103, the magnetic head, and so on in predetermined positions inside the housing 101.

### Second Embodiment

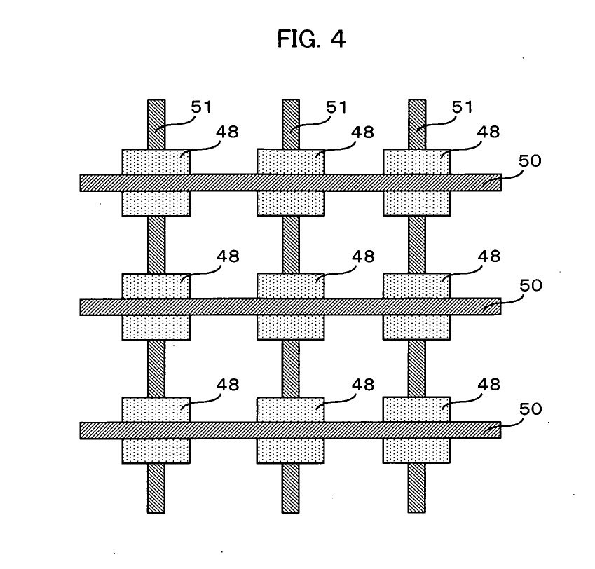

Next, a second embodiment of the present invention will be described. In the second embodiment, a nonvolatile magnetic memory device (MRAM: magnetic random access memory) such as shown in FIG. 4 will be manufactured. FIG. 4 is a schematic view showing the constitution of the MRAM.

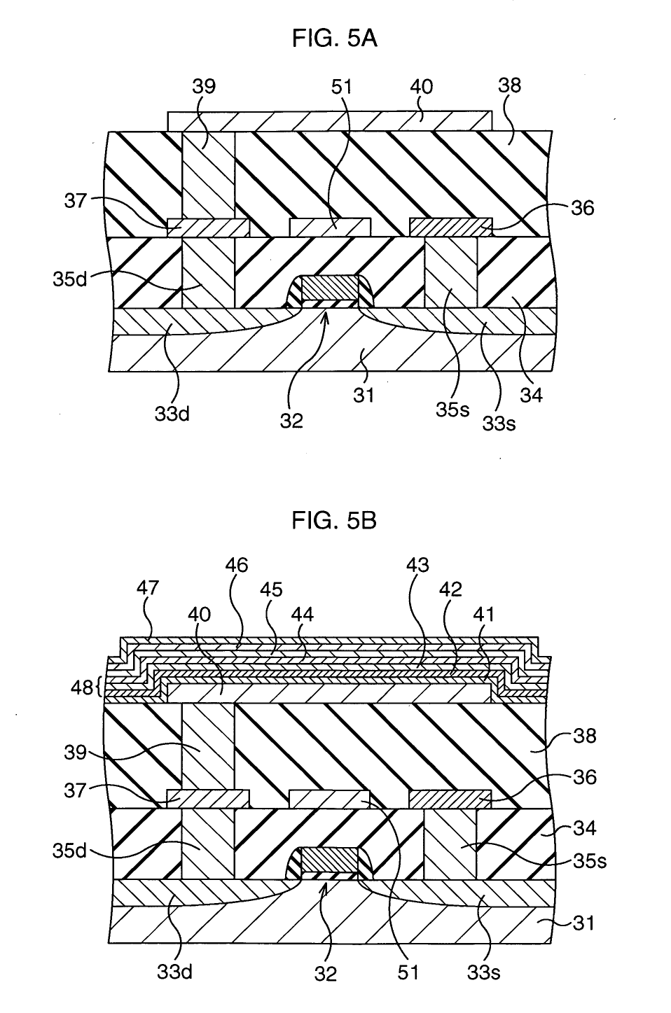

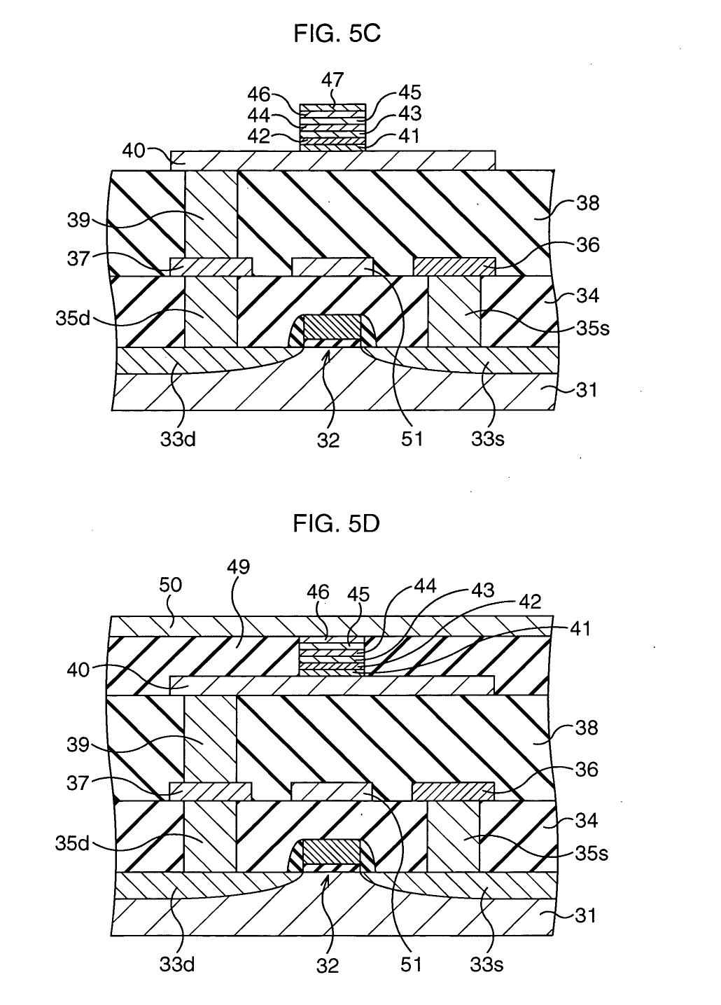

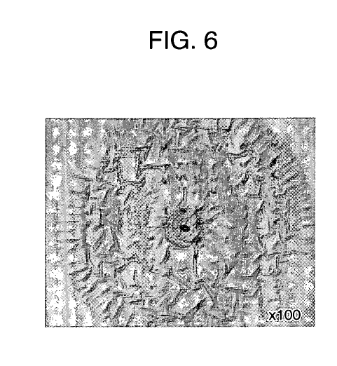

In the MRAM, plural bit lines 50 are arranged parallel to each other, and further plural writing word lines 51 crossing these bit lines 51 are arranged. A TMR film 48 is formed in each position where the bit line 50 and the writing word line 51 cross each other. Such an MRAM can be manufactured in the following manner. FIG. 5A to FIG. 5D are sectional views showing a manufacturing method of the semiconductor memory device (MRAM) according to the second embodiment of the present invention step by step.

First, as shown in FIG. 5A, plural MOS transistors 32 each including a source impurity diffusion layer 33s and a drain impurity diffusion layer 33d are formed in an array on the surface of a silicon substrate 31. The MOS transistor 32 acts as a switching element, and the number thereof is equal to that of the TMR films 48. A gate electrode is shared among the plural MOS transistors 32, and this gate electrode is used as a reading word line. Then, an interlayer insulating film 34 made of SiO₂ or the like and covering the MOS transistors 32 is formed, and its surface is planarized. Subsequently, openings reaching the source impurity diffusion layer 33s and the drain impurity diffusion layer 33d, respectively, are formed in the interlayer insulating film 34. Thereafter, a conductive plug 35s contacting the source impurity diffusion layer 33a and a conductive plug 35d contacting the drain impurity diffusion layer 33d are formed. Then, a conductive film such as an Al film is formed on the interlayer insulating film 34 and patterned, thereby forming a wiring 36 contacting the conductive plug 35s, a conductive pad 37 contacting the conductive plug 35d, and the writing word line 51. The wiring 36 and the writing word line 51 are formed so as to extend parallel to the reading word line (gate electrode of the MOS transistor 32).

Next, an interlayer insulating film 38 made of SiO₂ or the like and covering the wiring 36, the conductive pad 37, and the writing word line 51 is formed, and its surface is planarized. Subsequently, an opening reaching the conductive pad 37 is formed in the interlayer insulating film 38. Thereafter, a conductive plug 39 contacting the conductive pad 37 is formed in the opening. Then, a conductive film such as an Al film is formed on the interlayer insulating film 38 and patterned, thereby forming a wiring 40 contacting the conductive plug 39.

Next, as shown in FIG. 5B, an antiferromagnetic film 41, a ferromagnetic film 42, a tunnel insulating film 43, a ferromagnetic film 44, a Ta film 45, a Ru film 46, and a Ta film 47 are formed in sequence on the entire surface, for example, by a sputtering method. As the antiferromagnetic film 41, for example, an IrMn film, a Pt Mn film, or the like is formed. As the ferromagnetic films 42 and 44, for example, a CoFe film, a NiFe film, or the like is formed. As the tunnel insulating film 43, for example, a MgO film, an Al₂O₃ film, a TiOₓ film, or the like is formed. The thickness of the Ta film 47 is, for example, about 0.5 nm (almost the same as the thickness of one atomic layer). Incidentally, the Ta film 47 is naturally oxidized after being formed. In this embodiment, the ferromagnetic film 42, the tunnel insulating film 43, and the ferromagnetic film 44 constitute a TMR film 48.

After a stacked body such as described above is formed, heat treatment to improve the characteristic of the TMR film 48 is performed. The temperature of this heat treatment is, for example, approximately from 200° C. to 300° C. In a conventional manufacturing method, film peeling occurs during this heat treatment, and accompanying this, defects such as occurrence of holes and wrinkles further occur, but also in this embodiment, as in the first embodiment, such an occurrence of defects is prevented since the Ta film 47 is formed at the uppermost surface.

Then, as shown in FIG. 5C, the Ta film 47, the Ru film 46, the Ta film 45, the ferromagnetic film 44, the tunnel insulating film 43, the ferromagnetic film 42, and the antiferromagnetic film 41 are patterned by a photolithography technique and an etching technique. At this time, remaining portions of the Ta film 47, the Ru film 46, the Ta film 45, the ferromagnetic film 44, the tunnel insulating film 43, the ferromagnetic film 42, and the antiferromagnetic film 41 are positioned above the writing word line 51.

Subsequently, as shown in FIG. 5D, an interlayer insulating film 49 made of SiO₂ or the like is formed on the entire surface and planarized until the Ru film 46 is exposed. Namely, the Ta film 47 is removed. As a result, the surface of the Ru film 46 is naturally oxidized, but its accompanying increase in resistance is acceptable. Thereafter, a conductive film such as an Al film is formed on the interlayer insulating film 49 and patterned, thereby forming the bit line 50. At this time, the bit line 50 is formed to cross the writing word line 51.

In such a second embodiment, in manufacturing the MRAM, the Ru film 46 is covered with the Ta film 47 at the time of heat treatment, so that, similarly to the first embodiment, defects such as film peeling are suppressed. Accordingly, reductions in yield and reliability can be suppressed.

Now, the operation of the MRAM shown in FIG. 4 will be described.

In a write operation, a current is passed through the bit line 50 and the writing word line 51 which cross each other via the TMR film 48 as an object to be written. As a result, a magnetic field is formed around this TMR film 48, and the direction of magnetization in the ferromagnetic film 44 acting as a magnetization free layer is controlled. Either of two types of data (0 or 1) is stored according to whether the direction of magnetization in the ferromagnetic film 44 is the same as or opposite to the direction of magnetization in the ferromagnetic film 42 acting as a magnetization fixed layer.

On the other hand, in a read operation, the MOS transistor 32 connected to the TMR film 48 as an object to be read is turned on, and simultaneously a current is passed through the bit line 50. The resistance of the TMR film 48 is low if the directions of magnetization in the ferromagnetic films 42 and 44 are the same, whereas it is high if these directions are opposite. Accordingly, by detecting a potential difference between the bit line 50 and the wiring 36, the state of magnetization in the TMR film 48 can be identified, and thereby it can be read which data is stored.

Incidentally, it is desirable that the thickness of a metal film such as the Ta film or a metal oxide film formed on the Ru film be from 0.2 nm to 5 nm. If the thickness of this film is less than 0.2 nm, adsorption of moisture and the like occurs, which may cause defects such as film peeling as in the related art. Further, the metal film or the metal oxide film on the Ru film can act as a mask in fabrication, so that if its thickness exceeds 5 nm, its cross-sectional shape sometimes becomes trapezoidal, and the magnetic stability required for the magnetic head sometimes becomes insufficient.

Furthermore, the metal film such as the Ta film or the metal oxide film need not be removed if this film exhibits conductivity, but if it is used in the TMR head, a thickness of 5 nm or less is preferable. This is for the purpose of shortening the distance between a detecting part (mainly the magnetization free layer) of the TMR head called a read gap and stabilizing the shape at the time of fabrication. To shorten the read gap, it is necessary to reduce a thickness between both electrodes constituting the TMR head, and if the thickness of the metal film or the metal oxide film on the Ru film exceeds 5 nm, this reduction in thickness becomes difficult.

According to the present invention, a metal film or a metal oxide film is formed on a ruthenium film during a period from when the ruthenium film is formed until when heat treatment is performed, which can suppress defects such as film peeling in the heat treatment. Further, since this film is not indispensable to a device and can be removed later, it may be removed if the resistance is extremely high or the like.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A manufacturing method of a tunnel magnetoresistance element, comprising the steps of:
forming a first ferromagnetic film;
forming a tunnel insulating film on the first ferromagnetic film;
forming a second ferromagnetic film on the tunnel insulating film;
forming a ruthenium film electrically connected to the second ferromagnetic film above the second ferromagnetic film;
forming a metal film or a metal oxide film on the ruthenium film; and
performing heat treatment of the first ferromagnetic film, the tunnel insulating film, and the second ferromagnetic film.

2. The manufacturing method of the tunnel magnetoresistance element according to claim 1, further comprising the step of forming a tantalum film on the second ferromagnetic film between said step of forming the second ferromagnetic film and said step of forming the ruthenium film.

3. The manufacturing method of the tunnel magnetoresistance element according to claim 1, further comprising the step of processing the first ferromagnetic film, the tunnel insulating film, the second ferromagnetic film, and the ruthenium film, and removing a film resulting from oxidation of the metal film or the metal oxide film after said step of performing the heat treatment.

4. The manufacturing method of the tunnel magnetoresistance element according to claim 1, further comprising the step of removing a film resulting from oxidation of the metal film or the metal oxide film after said step of performing the heat treatment.

5. The manufacturing method of the tunnel magnetoresistance element according to claim 1, wherein as the metal film, one kind of film selected from the group consisting of a tantalum film, an aluminum film, a copper film, a magnesium film, and a titanium film is formed.

6. The manufacturing method of the tunnel magnetoresistance element according to claim 1, wherein as the metal oxide film, an oxide film of one kind of metal selected from the group consisting of tantalum, aluminum, copper, magnesium, and titanium is formed.

7. The manufacturing method of the tunnel magnetoresistance element according to claim 1, wherein a thickness of the metal film or the metal oxide film is from 0.2 nm to 5 nm.

8. The manufacturing method of the tunnel magnetoresistance element according to claim 1, wherein as the tunnel insulating film, one kind of film selected from the group consisting of a magnesium oxide film, an aluminum oxide film, and a titanium oxide film is formed.

9. A manufacturing method of a nonvolatile memory device, comprising the steps of:
forming a switching element;
forming a first ferromagnetic film connected to the switching element;
forming a tunnel insulating film on the first ferromagnetic film;
forming a second ferromagnetic film on the tunnel insulating film;
forming a ruthenium film electrically connected to the second ferromagnetic film above the second ferromagnetic film;
forming a metal film or a metal oxide film on the ruthenium film; and
performing heat treatment of the first ferromagnetic film, the tunnel insulating film, and the second ferromagnetic film.

10. The manufacturing method of the nonvolatile memory device according to claim 9, further comprising the step of forming a tantalum film on the second ferromagnetic film between said step of forming the second ferromagnetic film and said step of forming the ruthenium film.

11. The manufacturing method of the nonvolatile memory device according to claim 9, further comprising the step of removing a film resulting from oxidation of the metal film or the metal oxide film after said step of performing the heat treatment.

12. The manufacturing method of the nonvolatile memory device according to claim 9, wherein as the metal film, one kind of film selected from the group consisting of a tantalum film, an aluminum film, a copper film, a magnesium film, and a titanium film is formed.

13. The manufacturing method of the nonvolatile memory device according to claim 9, wherein as the metal oxide film, an oxide film of one kind of metal selected from the group consisting of tantalum, aluminum, copper, magnesium, and titanium is formed.

14. The manufacturing method of the nonvolatile memory device according to claim 9, wherein a thickness of the metal film or the metal oxide film is from 0.2 nm to 5 nm.

15. The manufacturing method of the nonvolatile memory device according to claim 9, wherein as the tunnel insulating film, one kind of film selected from the group consisting of a magnesium oxide film, an aluminum oxide film, and a titanium oxide film is formed.
